(19) United States
(12) Patent Application Publication
(10) Pub. No.: US 2019/0383726 A1
(43) Pub. Date: Dec. 19, 2019

(54) FLOW CELL FOR OPTICAL MEASUREMENT

(71) Applicant: NATIONAL INSTITUTE OF ADVANCED INDUSTRIAL SCIENCE AND TECHNOLOGY, Tokyo (JP)

(72) Inventors: Haruhisa KATO, Tsukuba-shi (JP); Ayako NAKAMURA, Tsukuba-shi (JP)

(21) Appl. No.: 16/471,669

(22) PCT Filed: Dec. 20, 2017
(86) PCT No.: PCT/JP2017/045750

§ 371 Date: Jun. 20, 2019

(30) Foreign Application Priority Data
Dec. 27, 2016 (JP) 2016-253627

(51) Int. Cl. G01N 15/14

(52) U.S. Cl. CPC G01N 15/1436; G01N 15/1404

(57) ABSTRACT

A flow cell for optical measurement capable of accurately measuring light emitted from particles, which is caused by a laser light provided into the flow path. A flow path block having a substantially cuboid shape and made of a transparent material is detachably interposed between a pair of a fluid medium inlet block and a fluid medium outlet block, and a light absorbing surface of the fluid medium inlet block and a light absorbing surface of the fluid medium outlet block are pressed against both end surfaces of the flow path block, respectively. The flow path is provided along a central axis of the flow path block to penetrate through the flow path block between the both end surfaces, and optical windows are detachably provided in outer end opening portions of extended flow paths along the central axis, to seal the outer end opening portions. Inlet and outlet paths for the fluid medium are provided along an introduction axis which intersects the central axis in the vicinity of the outer end opening portions.

### TECHNICAL FIELD

The present invention relates to a flow cell for optical measurement which optically measures particles in a fluid medium flowing through a flow path.

### BACKGROUND ART

In optical measurement performed for quality management at factory lines or various research, a fluid medium flowing through a flow path is irradiated with light, and the intensity of scattering light from particles in the fluid medium is optically measured. In the measurement, a flow cell including a flow path provided with an optical window is used, light is guided into the flow path from the outside via the optical window, and scattering light output via the optical window is measured outside the flow cell. Among the flow cells for optical measurement, there is known an axial flow cell in which light parallel with the direction of a flow path is provided into a fluid medium.

For instance, in a flow cell for optical measurement disclosed in Patent Document 1 and Patent Document 2, a grinded hole is provided along the diameter of a circular cross section of a circular columnar block made of a transparent medium such as glass or plastic so as to perpendicularly intersect a central axis of the circular columnar block, a fluid medium flows through these tubular straight flow path, and laser beams are provided in parallel with the tubular straight flow path. Since scattering light is measured at an outer circumference of the circular columnar block made of the transparent medium, and the circular columnar block forms a convex lens, it is possible to efficiently capture the scattering light in the measurement. Because laser beams are straight guided into the tubular flow path, the fluid medium is introduced in a direction perpendicular to the tubular flow path, and does not interfere with a light source.

In an axial flow cell disclosed in Patent Document 3 in which a fluid medium is introduced into a tubular flow path from an inlet path and a discharge path extending in a direction perpendicular to the tubular flow path, an inclined surface is provided at a point where a central axis of each of the inlet path and the discharge path intersects a central axis of the tubular flow path. Laser beams also are guided through the inclined surface. Even though bubbles enter the tubular flow path, the bubbles may be pushed out by the inclined surface without stagnation, and thus it is possible to correctly perform optical detection.

Patent Document 4 also discloses an axial flow cell in which a fluid medium is introduced into a tubular flow path in a direction perpendicular to the tubular flow path. It is possible to correctly perform optical detection by providing rotation, velocity changes, and turbulent flows to a fluid medium via a spiral groove formed in an inner wall of the tubular flow path, and pushing bubbles out of the tubular flow path.

### CITATION LIST

### Patent Literature

[Patent Document 1] Japanese Unexamined Patent Application, First Publication No. 2010-286491

[Patent Document 2] Japanese Unexamined Patent Application, First Publication No. 2015-111163

[Patent Document 3] Japanese Unexamined Patent Application, First Publication No. 2008-191119

[Patent Document 4] Japanese Unexamined Patent Application, First Publication No. 2008-233039

### SUMMARY OF INVENTION

### Technical Problem

In the whole range of flow cells for optical measurement which optically measures particles in a fluid medium flowing through a flow path, it is desirable to improve the accuracy of optical detection, and there is proposed a method of suppressing bubbles or stray light in the fluid medium inside the flow cell.

The inventors have proposed a method of measuring particle sizes from the displacements of fine particles contained in the fluid medium inside the flow cell by arranging scattering bright points resulting from the fine particles using Brownian motion. In the method, it is possible to recognize the material of the particles from the intensity of scattering light, and it is necessary to improve the accuracy of measurement of the intensity of scattering light which is to be detected. Also in this case, not only bubbles in the fluid medium inside the flow cell but also stray light affect the accuracy of measurement, and thus it is necessary to suppress the bubbles and the stray light.

The present invention has been made in light of the problems, and an object of the present invention is to provide a flow cell for optical measurement which optically measures particles in a fluid medium flowing through a flow path, and by which it is possible to stably and accurately measure light emitted from the particles, which is caused by a laser light provided into the flow path.

### Solution to Problem

According to the present invention, there is provided a flow cell for optical measurement which provides a laser light substantially in parallel with a flow direction in a flow path, and is configured to optically measure particles in a fluid medium flowing through the flow path, in which a flow path block having a substantially cuboid shape and made of a transparent material is detachably interposed between a pair of a fluid medium inlet block and a fluid medium outlet block, and a light absorbing surface of the fluid medium inlet block and a light absorbing surface of the fluid medium outlet block are pressed against both end surfaces of the flow path block, respectively, in which the flow path is provided along a central axis of the flow path block to penetrate through the flow path block between the both end surfaces, and in which an extended flow path is provided along the central axis to penetrate through each of the fluid medium inlet block and the fluid medium outlet block, an optical window is detachably provided in an outer end opening portion of the extended flow path to seal the outer end opening portion, and inlet and outlet paths for the fluid medium are provided along an introduction axis which intersects the central axis in the vicinity of the outer end opening portion.

According to the present invention, it is possible to prevent the occurrence of stray light by capable of providing the laser light to only the flow path penetrating through the flow path block between both end surfaces provided with the light absorbing surfaces, and thus it is possible to stably and accurately measure light emitted from the particles, which is caused by a laser light provided into the flow path. Because it is possible to disassemble the flow cell for optical measurement, and to easily clean the inside of the flow cell for optical measurement, reproducibility is good, and it is possible to stably and accurately measure light.

In the present invention, scattering light of the laser light from a direction having an angle with respect to the central axis may be detected. According to the present invention, it is possible to correctly capture movements of the particles, and to correctly measure particle sizes or a flow velocity distribution.

In the present invention, the flow path may be formed by a straight tube, and have a quadrilateral cross section. According to the present invention, it is possible to prevent the occurrence of stray light by capable of providing the laser light to only the flow path penetrating through the flow path block between both end surfaces provided with the light absorbing surfaces, and thus it is possible to stably and accurately measure the light emitted from the particles, which is caused by a laser light provided into the flow path.

In the present invention, the extended flow path may have a greater cross-sectional area than a cross section of the flow path, to reduce a flow velocity in the flow path. The extended flow path may have a circular cross section. The introduction axis may be inclined from a perpendicular line with respect to the central axis to induce a flow component toward the flow path block. According to the present invention, it is possible to stabilize the flow of the fluid medium from the inlet path and to the outlet path, and it is possible to prevent the occurrence of stray light by capable of providing the laser light to only the flow path penetrating through the flow path block between both end surfaces provided with the light absorbing surfaces, and thus it is possible to stably and accurately measure the light emitted from the particles, which is caused by a laser light provided into the flow path.

In the present invention, an expanded portion formed by expanding a central portion of the flow path may be provided. The expanded portion may have a hexagonal columnar shape having an axis perpendicular to the central axis. According to the present invention, it is possible to stabilize the flow of the fluid medium from the inlet path and to the outlet path, and it is possible to prevent the occurrence of stray light, and thus it is possible to stably and accurately measure the light emitted from the particles, which is caused by a laser light provided into the flow path.

In the present invention, the expanded portion may form a flow velocity vector not including a component in a direction of the axis and formed of only a component parallel with the central axis. Scattering light of the laser light from a direction substantially perpendicular to the central axis may be detected. According to the present invention, it is possible to correctly capture movements of the particles, and to correctly measure particle sizes or a flow velocity distribution.

### BRIEF DESCRIPTION OF DRAWINGS

FIG. 1 is a schematic cross-sectional view showing a flow cell for optical measurement according to the present invention.

FIG. 2 is a cross-sectional view showing the flow cell for optical measurement according to the present invention.

FIG. 3 is a plan view showing the flow cell for optical measurement according to the present invention.

FIG. 4 is a cross-sectional view showing main parts of the flow cell for optical measurement according to the present invention.

FIG. 5 is a perspective view of a flow cell used for fluid simulation.

FIG. 6 is a view showing flow lines inside the flow cell shown in FIG. 5.

FIG. 7 is a graph showing the horizontal position dependence of a flow velocity in a central portion of the flow cell shown in FIG. 5.

FIG. 8 is a graph showing the perpendicular position dependence of the flow velocity in the central portion of the flow cell shown in FIG. 5.

### DESCRIPTION OF EMBODIMENTS

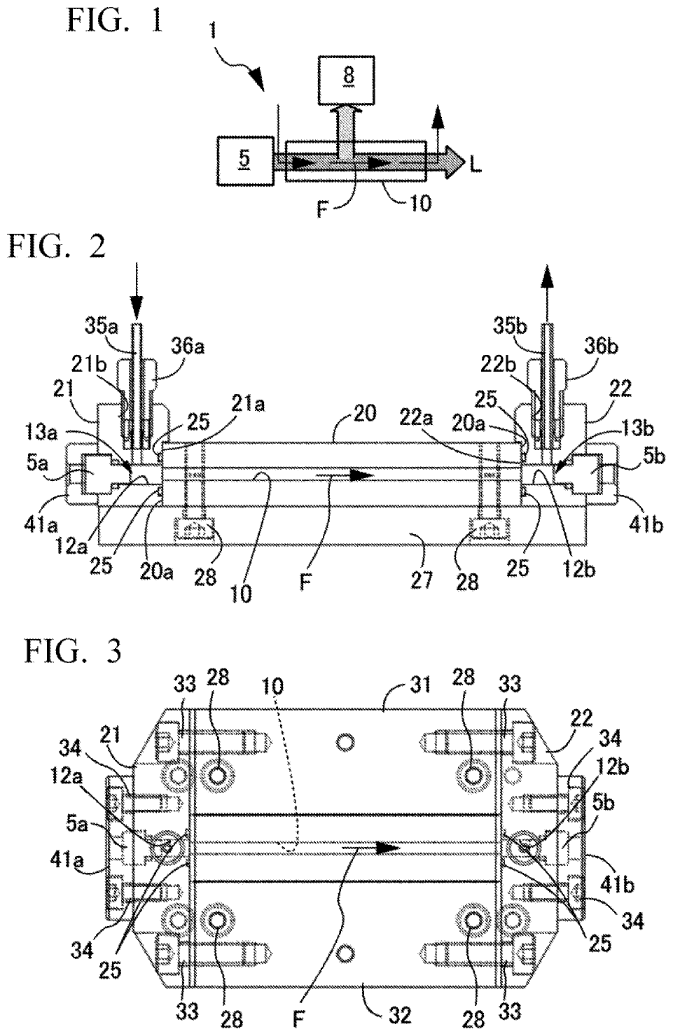

Hereinbelow, a flow cell for optical measurement according to one embodiment of the present invention will be described with reference to FIGS. 1 to 4.

As shown in FIG. 1, a flow cell 1 for optical measurement causes a light source 5 to provide a luminous flux L such as a laser light substantially parallel with a flow direction F in a flow path 10, and is configured to optically measure particles in a fluid medium flowing through the flow path 10, for example, measures scattering light from the particles via a camera 8. Particularly, it is possible to more correctly capture movements of the particles, and to accurately measure particle sizes or a particle speed distribution by detecting scattering light of laser light from a direction having an angle with respect to the luminous flux L.

As shown in FIGS. 2 to 4, a flow path block 20 having a substantially cuboid shape and made of a transparent material is detachably interposed between a pair of a fluid medium inlet block 21 and a fluid medium outlet block 22 with a cushioning member 25 such as O-ring mounted between the flow path block 20 and the fluid medium inlet block 21 and with another cushioning member 25 mounted between the flow path block 20 and the fluid medium outlet block 22.

The flow path block 20 is an optical block formed by cutting quartz into a substantially cuboid shape. Both end surfaces 20a of the flow path block 20 are machined into smooth surfaces, and a through hole like a straight tube is machined to form the flow path 10 in a central portion of the flow path block 20. The cross-sectional shape of the through hole can be properly selected depending on the application, and in the embodiment, the cross-sectional shape is a quadrilateral shape, specifically, a square shape. The diameter of the tubular path may be changed, or only the width of the tubular path may be changed. The flow cell 1 may be provided with an expanded portion formed by greatly increasing the diameter of a central portion of the flow cell 1 or increasing the width of the central portion. In the flow cell 1, the flow path block 20 can be properly and easily replaced with another flow path block, and thus it is possible to replace the flow path block 20 depending on the application by preparing a plurality of flow path blocks, as will be described later.

The flow path block 20 may be formed of two optical blocks, the main surfaces of which are stacked on top of each other. In this case, the flow path 10 is formed by flat cutting the main surface of one optical block via milling, and then stacking the other optical block on one optical block. It is possible to form the flow path 10 having various shapes such as a hexagonal columnar flow path which will be described later.

The inlet block 21 and the outlet block 22 are members formed by metal machining. The inlet block 21 and the outlet block 22 together with side blocks 31 and 32 formed by metal machining are disposed in the form of well curb, and the side blocks 31 and 32 are fixed to side portions of the inlet block 21 and the outlet block 22 via bolts 33, respectively. That is, a pair of the inlet block 21 and the outlet block 22 are disposed spaced apart from each other by the width of each of the side blocks 31 and 32.

The side blocks 31 and 32 are fixed onto a base block 27 made of metal via bolts 28, and are structurally stable, thereby capable of reducing an excessive load applied to the optical block 20 made of quartz, and easily handling the flow cell 1 for optical measurement. A surface of the base block 27 and surfaces of the side blocks 31 and 32 which are in contact with the optical block 20 are formed as light absorbing surfaces by applying a light absorbing film for preventing stray light from the flow path 10 to each surface, for example, by applying a black paint or a black anodizing treatment to each surface.

The bolts 33 are screwed into the side blocks 31 and 32 such that a smooth surface 21a of the inlet block 21 and a smooth surface 22a of the outlet block 22 are brought into contact with and are pressed against both end surfaces 20a of the flow path block 20, respectively. The surfaces 21a and 22a are formed as light absorbing surfaces by applying a light absorbing film for preventing stray light from the flow path 10, for example, by applying the black paint or the black anodizing treatment to each of the surfaces 21a and 22a. The black paint or the black anodizing treatment may be applied to the entirety of each of the inlet block 21 and the outlet block 22.

The inlet block 21 and the outlet block 22 include extended flow paths 12a and 12b which are provided coaxially with and along the flow path 10 to penetrate through the inlet block 21 and the outlet block 22, respectively. Optical blocks 5a and 5b forming optical windows are pressed against outer end opening portions 13a and 13b by window pressing blocks 41a and 41b, respectively. The outer end opening portions 13a and 13b are sealed with the optical blocks 5a and 5b, respectively. The window pressing blocks 41a and 41b are detachably fixed to side portions of the inlet block 21 and the outlet block 22 via bolts 34, respectively, and the optical blocks 5a and 5b are also attachable and detachable.

The optical blocks 5a and 5b are properly connected to the light source (not shown) irradiating a laser light, or are assembled into the light source to provide the laser light into the flow path 10 along an axis of the flow path 10. Both axial end opening portions of the flow path 10 are detachably held by the optical blocks 5a and 5b while being interposed therebetween, thereby capable of easily disassembling the flow path 10 from the optical blocks 5a and 5b, changing the shape of the flow path 10, and easily increasing an internal pressure of the flow path 10.

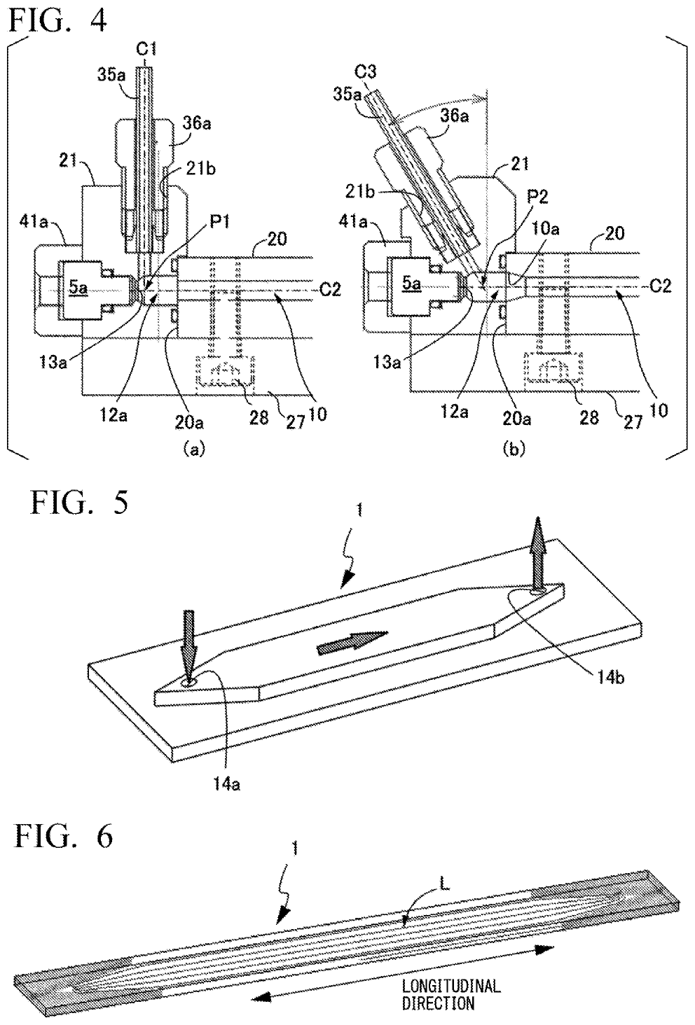

Particularly, as shown in FIG. 4, a fixation part 36a is inserted into a stepped through hole 21a penetrating through the inlet block 21 in a vertical direction, and is screw fixed to the stepped through hole 21a. An inlet pipe 35a forming an inlet path penetrates through the fixation part 36a in the vertical direction, and an insertion end portion of the inlet pipe 35a communicates with the extended flow path 12a.

Similarly, a fixation part 36b is inserted into a stepped through hole 22a penetrating through the outlet block 22 in the vertical direction, and is screw fixed to the stepped through hole 22a. An outlet pipe 35b forming an outlet path penetrates through the fixation part 36b in the vertical direction, and an insertion end portion of the outlet pipe 35b communicates with the extended flow path 12b.

The fluid medium supplied from the inlet pipe 35a flows into the flow path 10 via the extended flow path 12a, and flows out to the outlet pipe 35b via the extended flow path 12b.

Particularly, as shown in FIG. 4(a), an introduction axis C1 of the inlet pipe 35a intersects a central axis C2 of the flow path 10 in a vicinity P1 of the outer end opening portion 13a of the extended flow path 12a. The cross section of the extended flow path 12a is set to be greater than the cross section of the flow path 10 such that a flow velocity of the fluid medium decreases in the flow path 10. In the configuration, the flow path is bent at the extended flow path 12a, but it is possible to reduce the occurrence of bubbles.

As shown in FIG. 4(b), an introduction axis C3 of the inlet pipe 35a is inclined outwardly from a perpendicular line with respect to the central axis C2 of the flow path 10 to induce a flow component toward the flow path 10 of the flow path block 20. That is, the introduction axis C3 of the inlet pipe 35a intersects the central axis C2 of the flow path 10 in a vicinity P2 of the outer end opening portion 13a of the extended flow path 12a, and is moved closer to the flow path 10 than the introduction axis C1. In the configuration, the flow path is bent at the extended flow path 12a, but it is possible to further reduce the occurrence of bubbles.

As shown in FIG. 4(b), a taper 10a may be provided in the vicinity of an opening of the flow path 10 of the flow path block 20, the flow path is formed continuously from the extended flow path 12a to the flow path 10, thereby capable of further reducing the occurrence of bubbles, and reducing the accumulation of contaminants in the extended flow path 12a.

The flow cell for optical measurement described above has a structure in which at least the optical blocks 5a and 5b, the flow path block 20 providing the flow path 10, the fluid medium inlet block 21 and the fluid medium outlet block 22, the inlet pipe 35a, and the outlet pipe 35b are individual members manufactured from metal or quartz, and are detachably assembled together. Particularly, the flow path block 20 is interposed between the optical blocks 5a and 5b, and is held via both axial opening portions of the flow path 10. Therefore, it is possible to remove contamination by cleaning or replacing only a specific contaminated part, and thus it is possible to accurately and stably repeat optical measurement. Further, since corner portions of the blocks are bolt screwed, it is possible to improve the pressure resistance of the flow path 10, and to perform a high-capacity and high-flowrate online measurement.

Furthermore, as the flow path block 20 can be changed to another flow path block, it is possible to easily change a fluid transfer length, a fluid transfer width, or a fluid transfer shape of the flow path 10, and to select flowing optimal for a specific flowrate. As a result, it is possible to stably and accurately perform optical measurement.

Subsequently, the results of fluid simulation when the flow path 10 having the shape of hexagonal column is formed by the flow path block 20, the inlet block 21, and the outlet block 22 (refer to FIG. 3) in the flow cell 1 for optical measurement will be described.

As shown in FIG. 5, the flow cell 1 used for the fluid simulation has an expanded portion, and provides the flow path 10 having the shape of hexagonal column as the flow cell 1 is seen from the top. That is, an axis of the hexagonal column is perpendicular to the central axis of the flow path 10, and the flow path 10 is formed from one corner of the hexagonal column to another corner facing one corner. The flow cell 1 has a full length of 60 mm, a width of 6 mm, and a depth of 0.8 mm, and an inlet opening 14a and an outlet opening 14b, each of which has a circular shape, are provided in an upper surface of the flow cell 1. A steady flow is formed inside the flow cell 1 by allowing a fluid to be injected from the inlet opening 14a and concurrently allowing the fluid to be discharged from the outlet opening 14b, and by controlling an inlet and an outlet at a constant flowrate.

Herein, the imaginary fluid used for the simulation is assumed to be an incompressible fluid having a density of 1 g/cc and a viscosity of 1 cP, which is water.

A flow velocity distribution of the imaginary fluid at a flowrate of 1 cc/min has been simulated.

As shown in FIG. 6, flow lines L formed inside the flow cell 1 are parallel with each other over a wide range of distance in the expanded portion at the center of the flow cell 1. For this reason, it is determined that a flow velocity vector has components only in a longitudinal direction of the flow cell 1.

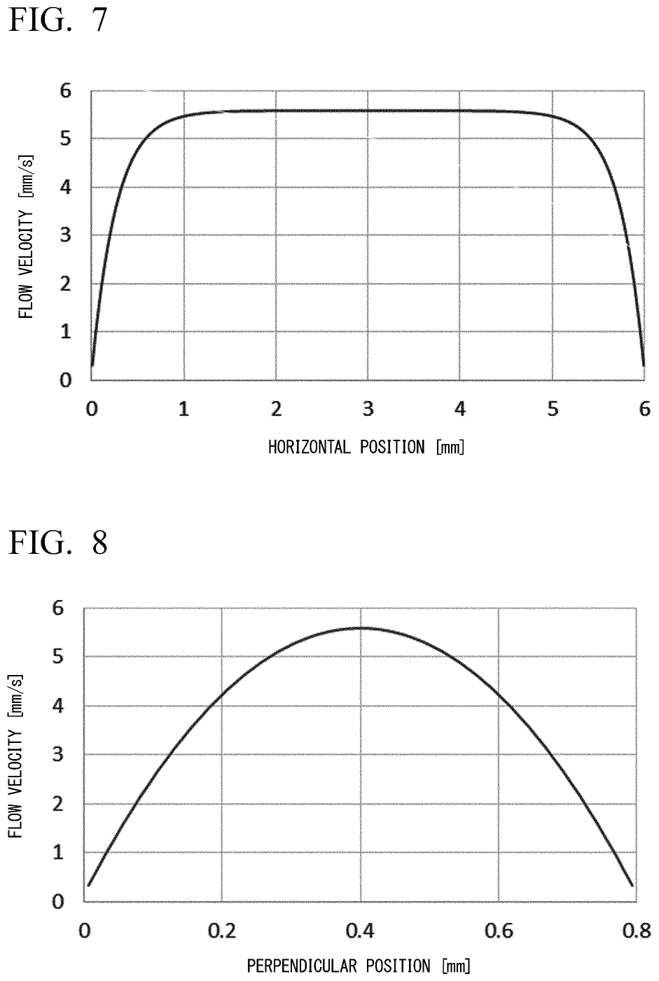

As shown in FIG. 7, upon analyzing the horizontal position dependence of a flow velocity of the imaginary fluid in the central portion of the flow cell 1, it is found that the slope of the flow velocity is steep in the vicinity of walls of the flow cell 1, and the flow velocity in the expanded portion at the center of the flow cell 1 is constant over a wide range of distance.

As shown in FIG. 8, upon analyzing the perpendicular position dependence of the flow velocity of the imaginary fluid in the expanded portion at the center of the flow cell 1, it is found that the flow velocity is parabolically distributed in a depth direction of the flow path 10, and a planar Poiseuille flow is formed.

The flow velocity distribution in a range of 15 mm before and after the center of the flow cell 1 in the longitudinal direction of the flow cell 1 is changed only by approximately 0.1% from the curves shown in FIGS. 7 and 8. As a result, in the flow velocity distribution inside the flow cell, a uniform flow can be regarded as being formed in a plane at a constant depth, and a spatial distribution may take account of only positions in the depth direction. That is, it is possible to correctly capture movements of particles in the flow path 10, and to correctly measure particle sizes or a flow velocity distribution by detecting scattering light of a laser light which is output from the inside of the flow cell 1 from the direction of the axis of the hexagonal column.

The exemplary example and the modification example based on the exemplary example of the present invention have been described; however, the present invention is not limited to the exemplary example and the modification example. A person skilled in the art can find various alternative examples without departing the scope of the accompanying claims.

### REFERENCE SIGNS LIST

1: flow cell for optical measurement
5: light source
5a, 5b: optical block
8: camera
10: flow path
12a, 12b: extended flow path
13a, 13b: outer end opening portion
20: flow path block
21: fluid medium inlet block
22: fluid medium outlet block
25: cushioning member
31, 32: side block
35a: inlet pipe
35b: outlet pipe
36a, 36b: fixed part
41a, 41b: window pressing block

What is claimed is:

1. A flow cell for optical measurement which provides a laser light substantially in parallel with a flow direction in a flow path, and is configured to optically measure particles in a fluid medium flowing through the flow path,
wherein a flow path block having a substantially cuboid shape and made of a transparent material is detachably interposed between a pair of a fluid medium inlet block and a fluid medium outlet block, and a light absorbing surface of the fluid medium inlet block and a light absorbing surface of the fluid medium outlet block are pressed against both end surfaces of the flow path block, respectively,
wherein the flow path is provided along a central axis of the flow path block to penetrate through the flow path block between the both end surfaces, and
wherein an extended flow path is provided along the central axis to penetrate through each of the fluid medium inlet block and the fluid medium outlet block, an optical window is detachably provided in an outer end opening portion of the extended flow path to seal the outer end opening portion, and inlet and outlet paths for the fluid medium are provided along an introduction axis which intersects the central axis in the vicinity of the outer end opening portion.

2. The flow cell for optical measurement according to claim 1,
wherein the flow cell is configured to detect scattering light of the laser light from a direction having an angle with respect to the central axis.

3. The flow cell for optical measurement according to claim 1,
wherein the flow path is formed by a straight tube, and has a quadrilateral cross section.

4. The flow cell for optical measurement according to claim 3,
wherein the extended flow path has a greater cross-sectional area than a cross section of the flow path, to reduce a flow velocity in the flow path.

5. The flow cell for optical measurement according to claim 4,
wherein the extended flow path has a circular cross section.

6. The flow cell for optical measurement according to claim 5,
wherein the introduction axis is inclined from a perpendicular line with respect to the central axis to induce a flow component toward the flow path block.

7. The flow cell for optical measurement according to claim 1,
wherein an expanded portion formed by expanding a central portion of the flow path is provided.

8. The flow cell for optical measurement according to claim 7,
wherein the expanded portion has a hexagonal columnar shape having an axis perpendicular to the central axis.

9. The flow cell for optical measurement according to claim 8,
wherein the expanded portion forms a flow velocity vector not including a component in a direction of the axis and formed of only a component parallel with the central axis.

10. The flow cell for optical measurement according to claim 9,
wherein the flow cell is configured to detect scattering light of the laser light from a direction substantially perpendicular to the central axis.
